(19) United States
(12) Patent Application Publication
(10) Pub. No.: US 2026/0121885 A1
(43) Pub. Date: Apr. 30, 2026

(54) ENHANCED NETWORK ARCHITECTURE FOR VEHICLES

(71) Applicant: Tesla, Inc., Austin, TX (US)

(72) Inventors: Michael Kessler, Austin, TX (US); Arash Bastanfard, Austin, TX (US); Ross Harvey, Austin, TX (US); Joseph Langevin, Austin, TX (US); Chris Copeland, Austin, TX (US)

(21) Appl. No.: 18/934,097

(22) Filed: Oct. 31, 2024

(51) Int. Cl. H04L 12/40; H04L 12/413; H04L 12/427; H04L 69/22

(52) U.S. Cl. CPC H04L 12/40032; H04L 12/413; H04L 12/427; H04L 69/22; H04L 2012/40215; H04L 2012/40273

(57) ABSTRACT

Aspects of this disclosure relate to a wiring system for an automobile. A wiring system may include controllers networked in in a loop topology and configured to encode and decode packets bi-directionally on the loop using Ethernet messages. A first controller may receive vehicle messages from a Controller Area Network (“CAN”) bus connected to a first subsystem of the automobile, generate an Ethernet message that includes vehicle messages within a data frame, and transmit the Ethernet message on the loop in two directions. A second controller may receive an Ethernet message from the loop, determine whether a second subsystem of the automobile is a recipient of vehicle messages in a data frame of the Ethernet message, generate a message that includes the vehicle messages, and transmit the message on a CAN bus connected to the second subsystem of the automobile.

### BACKGROUND

Traditional wiring systems typically connect devices to a central point, such as a processor, using a cable to connect each device to the processor. The processor communicates with each device individually. Typically, the cables transmit data from a device to the processor or from the processor to the device. That is, each cable can only transmit data in a single direction during operation. If one of the cables fails, then the communication to and from the device fails. That is, there is no redundancy. Such loss of communication negatively impacts the overall functioning of the system. When the data transmitted relates to driver-assist and autonomous-driving functionality, such decrease of system functionality may result in complete system failure and a compromised situation. Further, traditional wiring systems typically utilize specific connections between connected devices for each type of data that is communicated between the devices. As such, traditional wiring systems have a large physical footprint within a vehicle, have an increased manufacturing cost, and be difficult to replace or repair.

### SUMMARY

The innovations described in the claims each have several aspects, no single one of which is solely responsible for its desirable attributes. Without limiting the scope of the claims, some prominent features of this disclosure will now be briefly described.

In some aspects, the techniques described herein relate to a wiring system for an automobile. The wiring system can include a plurality of controllers networked in a loop topology and configured to encode and decode packets bi-directionally on the loop using Ethernet messages. The plurality of controllers can include a first controller with one or more processors. The first controller can be configured to receive one or more vehicle messages from a first Controller Area Network (“CAN”) bus connected to a first subsystem of the automobile, generate an Ethernet message that includes the one or more vehicle messages within a data frame, and transmit the Ethernet message on the loop in two directions. The plurality of controller can include a second controller with one or more processors. The second controller can be configured to receive the Ethernet message from the loop, determine whether a second subsystem of the automobile is a recipient of the one or more vehicle messages, generate a message that includes the one or more vehicle messages, and transmit the message on a second CAN bus connected to the second subsystem of the automobile.

In some embodiments, to determine that the second subsystem of the automobile is the recipient of the one or more vehicle messages, the second controller can use identification information in a header of the one or more vehicle messages.

In some embodiments, the identification information can reflect a type of the one or more vehicle messages.

In some embodiments, the second controller can be further configured to receive a second copy of the Ethernet message and discard the second copy of the Ethernet message.

In some embodiments, the plurality of controllers can further include a third controller with one or more processors. The third controller can be an infotainment controller and be configured to generate a second Ethernet message that includes audio data and transmit the second Ethernet message on the loop in a single direction.

In some embodiments, to determine whether the second subsystem of the automobile is the recipient of the one or more vehicle messages, the second controller can be configured to compare a portion of the one or more vehicle messages to a lookup table.

In some embodiments, a size of the data frame of the Ethernet message can be configured to be dynamically allocated based on an amount of the one or move vehicle messages.

In some embodiments, the first controller can be further configured to receive a second one or more vehicle messages and the Ethernet message generated by the first controller can include the second one or more vehicle messages.

In some embodiments, the first controller can receive the second one or more vehicle messages from a third CAN bus connected to a third subsystem of the automobile.

In some embodiments, the plurality of controllers can further include a third controller with one or more processors. The third controller can be configured to receive the Ethernet message from the loop, determine whether a fourth subsystem of the automobile is a recipient of the second one or more vehicle messages, generate a second message that includes the second one or more vehicle messages, and transmit the second message on a fourth CAN bus connected to the fourth subsystem of the automobile.

In some aspects, the techniques described herein relate to a method. The method can include generating, by a first controller of a plurality of controllers, an Ethernet message that includes one or more vehicle messages within a data frame, the plurality of controllers networked in a loop topology and configured to encode and decode packets bi-directionally on the loop using Ethernet messages. The method can include transmitting, by the first controller, the Ethernet message on the loop. The method can include, by each successive controller of the plurality of controllers along the loop: receiving the Ethernet message, determining whether at least one subsystem of an automobile connected to the successive controller is a recipient of the one or more vehicle messages, based on the determination that the at least one subsystem is the recipient of the one or more vehicle messages, generating a message that includes the one or more vehicle messages, and transmitting the message on a Controller Area Network (“CAN”) bus connected to the at least one subsystem.

In some embodiments, the method can further include receiving, by the first controller, the one or more vehicle messages from a subsystem of the automobile connected to the first controller.

In some embodiments, determining whether at least one subsystem of an automobile connected to the successive controller is a recipient of the one or more vehicle messages can include using identification information in a header of the one or more vehicle messages.

In some embodiments, the identification information reflects a type of the one or more vehicle messages.

In some embodiments, the method can further include, by each successive controller of the of successive controllers along the loop, receiving a second copy of the Ethernet message and discarding the second copy of the Ethernet message.

In some embodiments, determining whether the subsystem of the automobile connected to the successive controller is the recipient of the one or more vehicle messages can include comparing a portion of the one or more vehicle messages to a lookup table.

In some embodiments, the method can further include, by the first controller, dynamically allocating a size of the data frame of the Ethernet message based on an amount of the one or more vehicle messages.

In some embodiments, the method can further include generating, by the first controller, an additional Ethernet message that includes an additional one or more vehicle messages within the data frame, and by each successive controller of the plurality of controllers along the loop: receiving the additional Ethernet message, determining whether the subsystem of the automobile connected to the successive controller is a recipient of the additional one or more vehicle messages, based on the determination that the at least one subsystem is a recipient of the additional one or more vehicle messages, generating an additional message that includes the additional one or more vehicle messages, and transmitting the additional message on the CAN bus connected to the at least one subsystem.

In some embodiments, the method can further include, by each successive controller of the of successive controllers along the loop, based on the determination that the at least one subsystem is the recipient of the one or more vehicle messages, storing the one or more vehicle messages in a queue. In some embodiments, the message can include all vehicle messages stored in the queue.

In some embodiments, generating the message can include generating the message from all vehicle messages stored in the queue at set intervals.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1A is a block diagram illustrating a wiring architecture for a vehicle using an Ethernet loop, according to various embodiments.

FIG. 1B is a block diagram illustrating communicating Ethernet messages on an Ethernet loop, according to various embodiments.

FIG. 2 is a block diagram illustrating ports of a controller receiving and transmitting data.

FIG. 3A illustrates an example Ethernet message, according to an embodiment.

FIG. 3B illustrates an example vehicle payload, according to an embodiment.

FIG. 3C illustrates an example vehicle message, according to an embodiment.

FIGS. 4A and 4B are example processes of communicating vehicle messages on Ethernet messages using an Ethernet loop, according to various embodiments.

FIG. 5 is a block diagram illustrating an example controller, according to an embodiment.

### DETAILED DESCRIPTION

Generally described, one or more aspects of the present disclosure relate to a wiring architecture for a vehicle. A vehicle can require a large number of electrical connections. For example, vehicle components, such as sensors, actuators, controls, controllers, speakers, and other vehicle components, may all require one or more electrical connections to function. As such, a vehicle may have thousands or more individual wires providing these electrical connections. If every wire spans from a vehicle component to a corresponding and/or central processor, the total length of wiring in the vehicle can become significant, adding weight and bulk to the vehicle and increasing the complexity of manufacturing and repairing the vehicle. The total length of wiring in the vehicle can be reduced by introducing task and/or location specific controllers, such as ethernet controllers or network controllers (e.g., network interface controllers), to the vehicle that each connect to a subset of vehicle components (herein also referred to as vehicle subsystems). As will be described, individual controllers may communicate with other controllers to facilitate data transmission between vehicle components. For example, one controller may connect to a subsystem of lights on the back left of the vehicle (e.g., brake lights, directional blinkers, backup lights, etc.) and another controller may connect to a subsystem of directional blinker control. These two controllers may receive information from respective subsystems and communicate the information between the two controllers to facilitate the control of the subsystem of lights (e.g., turn on a back right directional blinker).

Data communication between controllers may require multiple data types to be communicated. Examples of such data types can be, but are not limited to vehicle messages (e.g., data communicated in the vehicle using controller area network (CAN) buses), media data (e.g., advanced authoring format (AAF) data, clock reference format (CRF) data, and/or other media data), synchronization data (e.g., precision time protocol (PTP) data), and/or security data (e.g., technical key management (TKM) data). A vehicle message can refer to data generated by a subsystem of the vehicle that is provided over a particular protocol to a controller for inclusion in an Ethernet message for routing to a different subsystem. Examples of the particular protocol may include a controller area network (CAN), a CAN with flexible data rate (CAN FD) communication protocol, and so on. Vehicle message can be used in operation of the vehicle and can include controls data to one or more subsystems or sensor data collected by one or more subsystems, to list a few examples.

Described herein is a wiring system for a vehicle that utilizes an Ethernet loop connection between controllers of the vehicle. According to various embodiments, the Ethernet loop can provide high-bandwidth, bi-directional communication along the loop. The Ethernet loop can allow for multiple data types, optionally provided over multiple protocols, to be packaged within an Ethernet message (e.g., within the data payload portion of the message). Further, the Ethernet loop can enable a virtualized CAN bus to be extended throughout the vehicle using Ethernet connections, eliminating the number of physical CAN buses used in the vehicle.

According to various embodiments, a controller in the wiring system can generate data of various types and/or receive data of various types from vehicle subsystems connected to the controller. For example, the controller can receive vehicle message from one or more vehicle subsystems. Example subsystems may include vehicle sensors, actuators, motor control systems, electronic control units (ECUs) (e.g., connected to other subsystems, such as sensors), and so on. As an example, a group of sensors may transmit signals to an ECU and a single CAN bus can connect a controller to the ECU. In some instances, the controller itself can generate data of various types. For example, a controller may generate both audio data and synchronization data.

A controller can generate an Ethernet message that aggregates vehicle message within a data frame of the Ethernet message. For example, the controller can receive vehicle message from one or more subsystems connected to the controller (e.g. using respective CAN buses, for example individual subsystems may be connected via individual CAN buses to a subsystem). In some embodiments, the Ethernet loop can transmit data provided from subsystems which are connected using disparate communication protocols. For example, a first controller can aggregate vehicle message and transmit Ethernet message(s) over the Ethernet loop. In this example, a second controller can aggregate data provided over a different protocol, such as audio data, and transmit Ethernet message(s) over the Ethernet loop. In some embodiments, a same controller can be in communication with subsystems that use different communication protocols.

Example data which may be routed over the Ethernet loop described herein is illustrated in Table 1 below. However, Table 1 is not meant to be limiting and other data types may be received, generated, and/or used int Ethernet messages. Further, the applications, transmit frequencies, and estimated bandwidths are provided as mere examples and the Data types shown may be used for other applications, transmitted at other frequencies, and consume other bandwidths than is illustrated in Table 1.

TABLE 1

| | | Transmit | | Estimated |
|---|---|---|---|---|
| Data Type | Application | Frequency | | Bandwidth |
| Vehicle | Vehicle | 2 | KHz | 32.5 Mbps |
| message | Operation | | | |
| Audio | Audio | 3 | KHz | 20.9 Mbps |
| (AAF) | Playback | | | |
| Audio | Audio | 350 | Hz | 0.2 Mbps |
| (CRF) | Clock Data | | | |
| PTP | System | 8 | Hz | 0.006 Mbps |
| | Clock Sync | | | |

| | | | |
|---|---|---|---|
| TKM | Security | — | — |
| | Handshake | | |

According to various implementations, Ethernet messages can include data of different data types within the data frame of the same Ethernet message and/or can include information from different data types within the data frames of separate Ethernet messages. In some circumstances, a receiving controller can use the information of different data types together. For example, AAF data can be data used to play audio throughout a vehicle. A controller can receive the AAF data along with CRF data and/or PTP data. The CRF data and/or PTP data can be used to synchronize the playback of the audio from the AAF data by the controller with other controllers of the vehicle.

The controller can generate an Ethernet message that includes multiple messages of data (e.g., vehicle message) withing the data frame. The controller can transmit the Ethernet message on the Ethernet loop. Because the Ethernet loop is bi-directional, the controller can transmit a copy of the Ethernet message in two directions on the Ethernet loop. This can improve system stability by providing multiple paths for the redundant signals to reach a destination and reduce latency in communication to other controllers on the Ethernet loop by allowing the other controllers to receive the Ethernet messages through the shortest path on the Ethernet loop.

According to some embodiments, the controller does not designate destination controller(s) for the vehicle messages included in an Ethernet message. Rather, each controller connected to the Ethernet loop can determine whether vehicle messages included in the Ethernet message is to be routed to a connected subsystem. For example, a controller can compare a portion of a vehicle message in the Ethernet message (e.g., information in a header of the vehicle message provided by a subsystem) to a data structure (e.g., a lookup table, array, mapping, function). In some embodiments In this example, the data structure (hereinafter lookup table) can identify headers (e.g., CAN message identifiers or types) and corresponding subsystems which are to receive vehicle messages that include the headers. The lookup table can also identify headers and corresponding CAN buses which are connected to respective subsystems. If the controller determines a portion of the Ethernet message is intended for the controller and/or a subsystem connected to the controller is a recipient of the vehicle message, the controller can extract the vehicle message (e.g., from the data frame of the Ethernet message). Subsequently, the controller transmits the extracted vehicle message to the corresponding subsystem over a CAN bus.

The controller can then transmit the above-described Ethernet message, optionally with the extracted vehicle messages removed, to a subsequent controller around the Ethernet loop. For example, the controller may forward and/or repackage the Ethernet message allowing that vehicle messages to be used by subsequent controllers on the Ethernet loop. According to some embodiments, each controller forwards a received Ethernet message along the Ethernet loop until the Ethernet message reaches the controller that originally generated the Ethernet message which may then discard the message.

As will be shown in more detail below, subsystems of the vehicle can communicate information as if connected directly by a bus (e.g., a CAN bus) even when connected to different controllers of the vehicle without direct bus communication. Further, the same information may be used by multiple subsystems of the vehicle without the need to generate the information on discrete buses for each of the subsystems that use the information. The wiring system described herein provides technical benefits to vehicles, such as reduced latency in communication, reduced overall wiring, redundant communications, and other benefits described herein. These benefits may improve transmitting information from sensors to an advanced driver assistance system (ADAS), such as for self-driving, autonomous, or semi-autonomous driving.

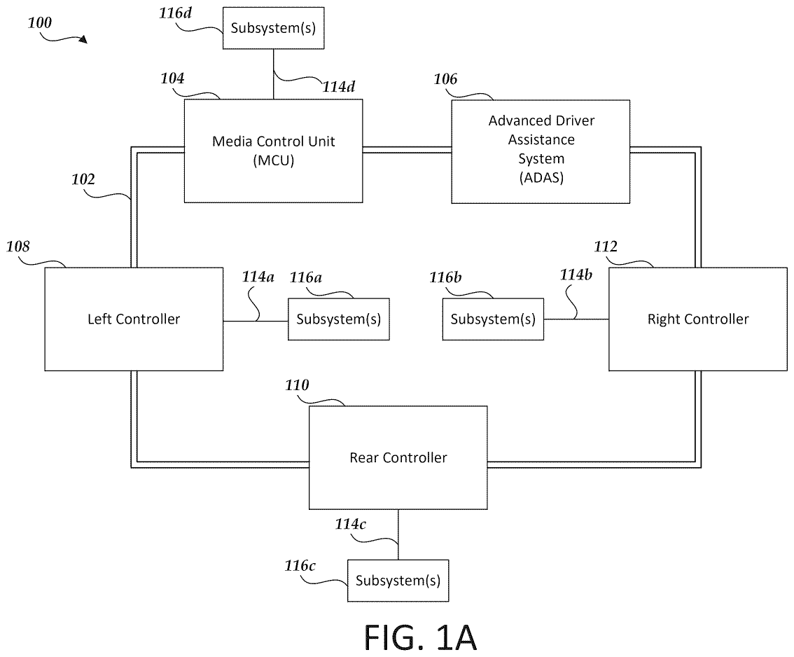

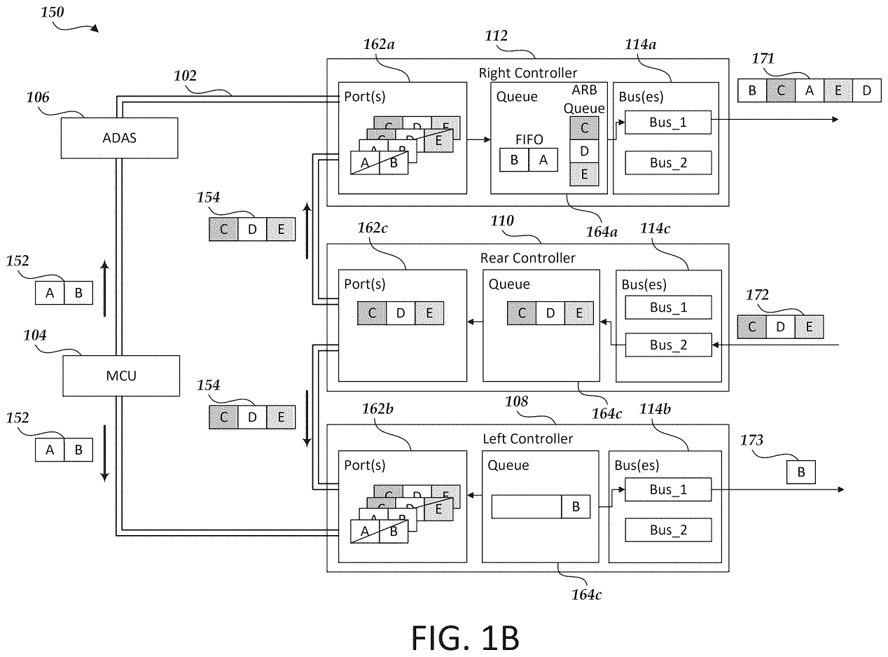

FIG. 1A is a block diagram illustrating a wiring architecture 100 for a vehicle using an Ethernet loop 102, according to various embodiments. In the illustrated embodiment, the wiring architecture 100 includes an Ethernet loop 102, a media control unit (MCU) 104 (also referred to as an “infotainment controller”), an ADAS 106, a left controller 108, a rear controller 110, a right controller 112, subsystems 116a-116d, and buses 114a-114d. The Ethernet loop 102 can include one or more Ethernet connections between the MCU 104, ADAS 106, left controller 108, rear controller 110, and right controller 112. The Ethernet loop 102 can network the MCU 104, ADAS 106, left controller 108, rear controller 110, and right controller 112 in a loop topology. The Ethernet loop 102 can facilitate bi-directional communication between the MCU 104, ADAS 106, left controller 108, rear controller 110, and right controller 112 (e.g., through packets of information).

The MCU 104, ADAS 106, left controller 108, rear controller 110, and right controller 112 can operate as controllers as described above. For example, each of the MCU 104, ADAS 106, left controller 108, rear controller 110, and right controller 112 can receive data from subsystems (e.g., subsystems 116a-116d), generate data, generate Ethernet messages, transmit Ethernet messages on the Ethernet loop 102 (e.g. encoding packets), receive Ethernet messages, extract data from Ethernet messages (e.g., decoding packets), generate messages for subsystems from the extracted data, and/or perform any other functions of controllers as described herein or known in the art. The MCU 104 and the ADAS 106 may each perform specific functions for the vehicle. For example, the MCU 104 may generate audio data, receive user input, and/or other functions. As another example, the ADAS 106 may generate vehicle control data. Each of the subsystems 116a-116d can be connected to a respective controllers (e.g., the MCU 104, the left controller 108, the rear controller 110, and the right controller 112). Each of the subsystems 116a-116d may include multiple subsystems. For example, subsystem 116a may include more than one subsystem.

The buses 114a-114d can connect respective controllers to the subsystems 116a-116d. In some embodiments, each of the subsystem of the vehicle (e.g., subsystems 116a-116d) is connected to a controller using a single CAN bus. For example, in the illustrated embodiment one or more buses 114a connect the left controller 108 to the subsystems 116a. The buses 114a-114b can be CAN buses, CAN FD buses, or any other suitable connection to facilitate communication between controllers and subsystems. The Ethernet loop 102 connects each of the MCU 104, ADAS 106, right controller 112, rear controller 110 and the left controller 108. The Ethernet loop 102 can provide high-bandwidth, bi-directional communication between the controllers. The Ethernet loop 102 can allow for multiple data types to be packaged within an Ethernet message (e.g., data in Ethernet frame format). As such, the Ethernet loop 102 may provide a desired bandwidth between controllers of the vehicle and reduce the number of individual wires needed to connect the controllers.

In some instances, a subsystem, such as subsystem 116a, may generate information that is to be used by another subsystem or a controller not directly connected to the subsystem 116a by bus 114a. In these instances, the subsystem 116a may communicate the information to the left controller 108 and the left control 108 generate an Ethernet message that includes the information from the subsystem 116 within a data frame of the Ethernet message. The Ethernet message can be sent in both directions on the ethernet loop 102. A controller that uses the information generated by the subsystem 116a (e.g. ADAS 106) and/or a controller that is connected to a subsystem that uses the information (e.g., right controller 112) can pull the information from the data frame of the Ethernet message. When the information is used by a subsystem connected to the controller (e.g., subsystem 116b), the controller can generate a message with the information and transmit the information using a bus (e.g., bus 114b).

FIG. 1B is a block diagram illustrating an example of transmitting vehicle messages in a vehicle using Ethernet messages. While FIG. 1B references the use of vehicle messages, other data types discussed herein, such as audio data (e.g., AAF of CRF) or clock synchronizing data (e.g., PTP), may be used. FIG. 1B illustrates a wiring system 150 for a vehicle. Wiring system 150 can include any of the features described with reference to wiring architecture 100 above. As illustrated, the right controller 112, rear controller 110, and the left controller 108 can each include one or more ports (e.g., ports 162a-162c), one or more queues (e.g., 164a-164c) and one or more buses (e.g., buses 114a-114c). The ports 162a-162c can be used to facilitate the insertion of vehicle messages into data frames of Ethernet messages, be used to determine whether the controller and/or subsystem connected to the controller is a recipient of the vehicle messages, and facilitate the generation of vehicle messages based on Ethernet messages. The queues 164a-164c may be used to store vehicle messages prior to the vehicle messages being sent to subsystems connected to the controller and to store vehicle messages provided by the subsystems to be sent in Ethernet messages. The queues 164a-164c can include various types of queues, such as first in first out (FIFO) queues and arbitrated queues (ARB queues), to list a few. The queues 164a-164c and the ports 162a-162c can be used to manage the ingress and egress of vehicle messages within the controllers.

According to the illustrated example, vehicle messages A-E are transmitted on the Ethernet loop 102. The vehicle message A and vehicle message B are included in an Ethernet message 152. As illustrated the Ethernet message 152 is generated by the MCU 104 and transmitted in both directions on the Ethernet loop 102. The vehicle message C, vehicle message D, and vehicle message E are included in an Ethernet message 154. The Ethernet message 154 is generated by the rear controller 110 and transmitted in both directions on the Ethernet loop 102.

In the illustrated example, the rear controller 110 receives vehicle message C, vehicle message D, and vehicle message E from a subsystem in a message 172 via the one of the buses 114c. The message 172 is placed in a queue 164c. Then the message 172 is placed a port 162c to be placed in a data frame of the ethernet message 154. For simplicity of illustration, only the right controller 112 and the left controller 108 are shown as receiving the Ethernet message 152 and the Ethernet message 154. However, the other controllers can receive the Ethernet message 152 and the Ethernet message 154 and perform similar operations described below with respect to the right controller 112 and the left controller 108.

Because the Ethernet messages are transmitted in both directions on the Ethernet loop 102, each controller can receive two copies of the same Ethernet message. For instance, two copies of the Ethernet message 152 and the Ethernet message 154 are illustrated in the port 162a of the right controller 112 and in the port 162b of the left controller 108. Each controller can discard duplicate Ethernet messages. Each controller can determine whether the controller is a recipient of any of the vehicle messages in the Ethernet messages. For example, each controller can determine whether a subsystem connected to the controller is a recipient of the vehicle message.

According to some implementations, when a controller (e.g. the left controller 108) determines the controller is a recipient of vehicle messages within the Ethernet messages, the controller places the vehicle messages into a queue. For example, in FIG. 1B, the left controller 108 determines the left controller 108 and/or a connected subsystem is a recipient of vehicle message B and places vehicle message B in the queues 164c. Further in the example, the right controller 112 determines the right controller and/or a connected subsystem is a recipient of vehicle message A-E and places vehicle messages A-E within the queues 164a. The controllers can generate one or more messages with the vehicle messages stored in the queues and transmit those messages on the connected buses. For example, the left controller transmits a message 173 with vehicle message B to a subsystem using a bus in the buses 114b. Similarly, the right controller 112 transmits a message 171 with vehicle messages A-E to a subsystem using a bus in the buses 144a.

According to some implementations, the order of the vehicle messages within a transmitted message may depend on the queues. For instance, the ARB queue of the queues 164a may place vehicle messages based on a controlled sequence, while the FIFO queue of the queues may place the next vehicle message in the queue, according to time entered. In the illustrated example, the ARB queue of the queues 164a places vehicle message D and vehicle message E first in the message 171. Then the ARB queue may not have asserted priority, allowing the FIFO queue of the queues 164a to place the next up vehicle message, vehicle message A, in the message 171. Next, the ARB queue places vehicle message C and the FIFO queue places vehicle message B in the message 171 and the message 171 is transmitted.

While FIG. 1B illustrates Ethernet messages with vehicle messages being sent bi-directionally on the ethernet loop 102, in some instances, and Ethernet message may be sent with other data types and only sent in one direction on the Ethernet loop 102. For example, audio, such as AAF data, may only be sent in one direction on the Ethernet loop 102. In some implementations, when audio data is sent on the Ethernet loop 102, a synchronizing signal, such as a PTP, is also sent on the Ethernet loop 102. In this way the audio data may also be sent on the Ethernet loop 102 while maintaining a synchronized audio playback throughout the vehicle.

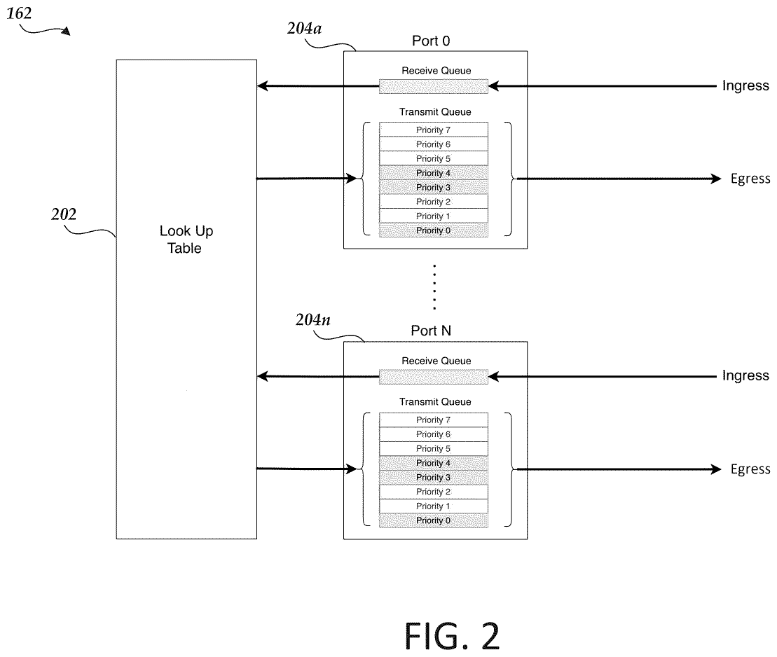

FIG. 2 is a block diagram illustrating the use of a lookup table to encode and decode Ethernet messages. According to various implementations of this disclosure, Ethernet messages can be encoded with identifying information, such as data type information and source information, priority rules, routing rules, and/or other information used in transmitting Ethernet messages or vehicle messages.

As illustrated above in FIG. 1B, a controller can include ports 162. As illustrated in FIG. 2, the ports 162 of a controller can include multiple ports 204a-204n and a lookup table 202. The ports 204a-204n can receive information, such as vehicle messages, from subsystems connected to the controller. The ports 204a-204n can also receive Ethernet messages from an Ethernet loop connected to the controller. The received information is illustrated in FIG. 2 as “Ingress” of the ports 204a-204n. The ports 204a-204n can transmit Ethernet messages onto the Ethernet loop and transmit other messages, such as vehicle messages, to subsystems via buses connected to the controller. The transmitted information is illustrated in FIG. 2 as “Egress” from the ports 204a-204n.

Each of the ports 204a-204n can include one or more receive queues. The receive queues can be used to hold the ingress information prior to encoding or decoding the information using the lookup table 202. The receive queues can be FIFO queues, ARB queues, and/or any suitable queue. In some implementations a receive queue may be a buffer configured to hold the ingress information until the encoding or decoding of the information can be performed. In the illustrated example, the same receive queue can be used for both Ethernet messages and other messages, such as vehicle messages from a CAN bus. In other implementations, different receive queues may be used for Ethernet messages and the other message.

Each of the ports 204a-204n can include one or more transmit queues. The transmit queues can be used to hold the egress information prior to the information being placed in a data frame of a message (e.g., an Ethernet message or in another message, such as vehicle messages from a CAN bus). In the illustrated example, the transmit queues are priority queues. The priority queues place the information with the highest priority (e.g., first “Priority 0,” then “Priority 1,” and so on) in the next message. The priority of the egress information may be based on the time the information has been held in the transmit queue, based on information from the lookup table 202, and/or based on other factors. Other queues may be used in the transmit queues. For example, the transmit queues can include FIFO queues, ARB queues, and/or any suitable queue. In the illustrated example, the same transmit queue can be used for both Ethernet messages and other messages, such as vehicle messages. In other implementations, different transmit queues may be used for Ethernet messages and the other message.

The lookup table 202 can include encoding and decoding information for the information in the ports 204a-204n. In some embodiments, the lookup table 202 may be used for decoding and not encoding. In some embodiments, encoding may include adding a vehicle message, optionally aggregated along with other vehicles messages, into an ethernet message (e.g., in the data frame). As an example of use of a lookup table 202, the lookup table 202 can include mapping to encode and/or decode data type information and source information, priority rules, routing rules, and/or other information used in transmitting Ethernet messages or other messages. According to various embodiments, the lookup table 202 can include virtual local area network (VLAN) rules used in the Ethernet messages, routing rules such as source indicators or other identifying information, priority rules used in the ports 204a-204n (or elsewhere), link status check information, and/or other information used in communicating information on the Ethernet loop or buses connected to the controller. While FIG. 2 illustrates the use of a lookup table, such as the lookup table 202, with the encoding and decoding information for the ports 204a-204n, a different data structure may be used. For example, any suitable data structure that maps, or other associates, the needed information for the encoding and decoding discussed herein may be used.

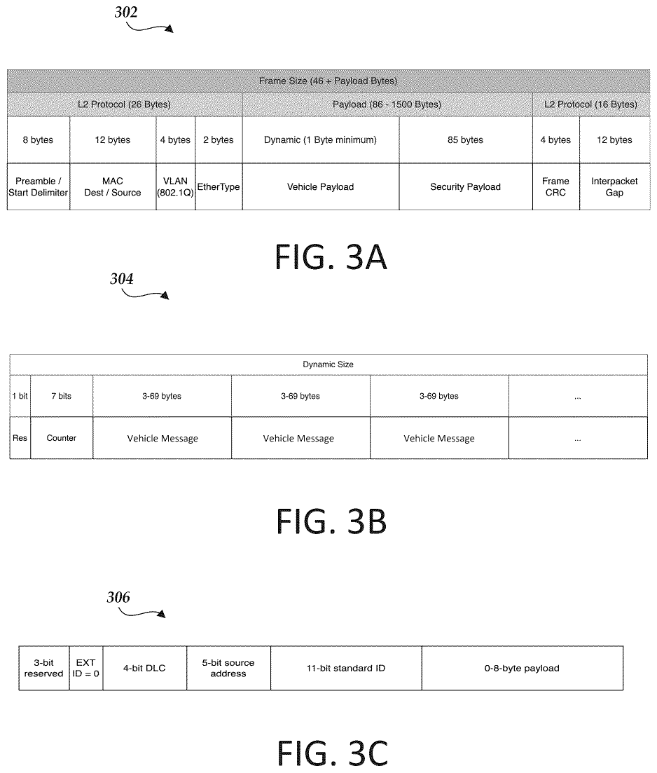

For illustration of example embodiments in which the lookup table is used for encoding, an example of the encoding of a received vehicle message for use in an Ethernet message is described below. In the example, the vehicle message is received in an ingress message and placed in the receive queue of port 204a. The controller then uses the lookup table 202 to encode information with the vehicle message. An example of a resulting vehicle message is illustrated in FIG. 3C. The controller can compare information in the vehicle message (e.g., information in the header of the vehicle message) to the lookup table 202 to map and/or encode the vehicle message with information based on that comparison (e.g., the controller may encode a higher priority to vehicle messages of a particular type). The encoding can include adding priority information, source information, identification information, other information used in Ethernet message communication, or any combination thereof. In some implementations, the controller uses the lookup table 202 to encode virtual local area network (VLAN) rules used in the Ethernet messages, routing rules such as source indicators or other identifying information, priority rules used in the ports 204a-204n (or elsewhere), link status check information, and/or other information used in communicating information on the Ethernet loop or buses connected to the controller. The vehicle message can be placed in a transmit queue of port 204a until the vehicle message is placed within a data frame of an Ethernet message in an egress message. As illustrated in FIG. 3B, the Ethernet message can include multiple vehicle messages within its data frames. According to some implementations, the Ethernet message does not designate a destination controller for the vehicle message. Rather, as is illustrated below, each controller can use the identification information to determine if the controller and/or a subsystem of the controller is a recipient of the vehicle message. However, in some implementations, the identification information and/or other encoded information can include destination identifying and/or destination designating information.

For illustration, an example of the decoding of a received Ethernet message to generate a message (e.g., a message with one or more vehicle messages) to be sent to a subsystem is described below. In the example, the Ethernet message is received in an ingress message and placed in the receive queue of port 204a. The controller then uses the lookup table 202 to decode the Ethernet message. For example, the controller can compare the identification information in a header of each vehicle message in the data frame of the Ethernet message to information in the lookup table 202 to determine if a subsystem connected to the controller is a recipient of the vehicle message. The information in the header of the can include identification information, such as a reflecting a type of the vehicle message, a message identification, or other information that can be used to map the vehicle message to a subsystem that uses the vehicle message. As in illustrative example, if a particular vehicle message includes information controlling brake lights, a controller connected to the brake lights can determine the controller is a recipient of the particular vehicle message. For each vehicle message in the Ethernet message a controller determines a subsystem connected to the controller is a recipient for, the controller can place the vehicle message in the transmit queue of port 204a until the vehicle message is placed within a message and transmitted to a subsystem in an egress message. In some embodiments, the lookup table 202 can include routing information that identifies an appropriate bus (e.g., a specified CAN bus) for a controller to route the vehicle messages to, such that the vehicle messages reaches the recipient subsystem (e.g., the subsystem may be connected to the appropriate bus, for example via a CAN bus).

FIG. 3A illustrates an example Ethernet message 302 according to various implementations. The Ethernet message 302 can include various information within the data frame of the Ethernet message. For instance, in the illustrated example, the Ethernet message 302 includes preamble/start delimiter data, media access control (MAC) destination/source data, VLAN data, Ethertype data, payload data, Frame cyclic redundancy check (CRC) data, and interpackct gap data. Some, or all of the preamble/start delimiter data, MAC destination/source data, VLAN data, Ethertype data, Frame CRC data, and interpacket gap data, each labeled as “L2 Protocol”, may be used to facilitate the transmission of the Ethernet message 302 on an Ethernet loop 102, may be used by a controller to detect duplicate copies of the Ethernet message 302, and/or otherwise used by controllers of the vehicle. The payload data can include the information being transmitted in the Ethernet message (e.g., vehicle messages) between the controllers. In the illustrated example the payload data includes vehicle payload data and security payload data. The vehicle payload data can include information (e.g., vehicle messages, audio data, and/or other information) from the various controllers and subsystems of the vehicle that is being shared with each other. The security payload data can include security information (e.g., encryption information) used to secure the information and protect against interference of vehicle operation). According to various implementations, the size of the payload data can be dynamically allocated within the data frame of the Ethernet message 302 depending on the amount of payload data that is queued to be sent within the Ethernet message.

FIG. 3B illustrates an example of vehicle payload data 304 that can be included in an Ethernet message, such as the Ethernet message 302 of FIG. 3A. The vehicle payload data 304 can include a reserved bit at the front of the vehicle payload data. The vehicle payload data 304 can also include counter data after the reserved bit that indicates the number of messages, such as vehicle messages, that are included within the vehicle payload data 304. In some embodiments, the vehicle payload data 304 includes multiple vehicle messages. Following the counter data, the vehicle payload data 304 can have one or more messages to be communicated in the Ethernet message. For example, FIG. 3B illustrates three vehicle messages included in the vehicle payload data 304. Each of the vehicle messages may have been generated by various subsystems on the vehicle and placed on the Ethernet loop by a controller so that other subsystems of the vehicle can use the vehicle messages. While FIG. 3B illustrates vehicle messages, other types of information can be placed in the vehicle payload data 304, such as AAF data, CRF data, PTP data, and TKM data, to list a few.

FIG. 3C illustrates an example vehicle message 306 that can be included in the vehicle payload data, such as the vehicle payload data 304 of FIG. 3B. The vehicle message 306 can include a header with front end data, such as the reserved bits, EXT identification data, DLC data, source address data, and standard ID data illustrated in FIG. 3C. The information in the header may be used by the various controllers of the vehicle to determine if the controller (or a subsystem connected to the controller) is a recipient of the vehicle message. For example, in some embodiments, the information in the header may indicate an originating subsystem of the vehicle message and may be used by a controller to determine a subsystem connected to the controller uses vehicle messages from the originating subsystem. The information in the header used by a controller to determine if the controller (or a subsystem connected to the controller) is a recipient of the vehicle message can be referred to as identification information. Other information encoded in the header may also be used by a controller as identification information, such as information identifying a type or function of the vehicle message 306. The identification information can be located in one or more portions of the header. For example, the one or both of the source address and the standard identification data may be used as identification data. The vehicle message 306 can include payload data. The payload data within the vehicle message 306 can include data generated by a subsystem of the vehicle that is being communicated from one controller to another along the Ethernet loop.

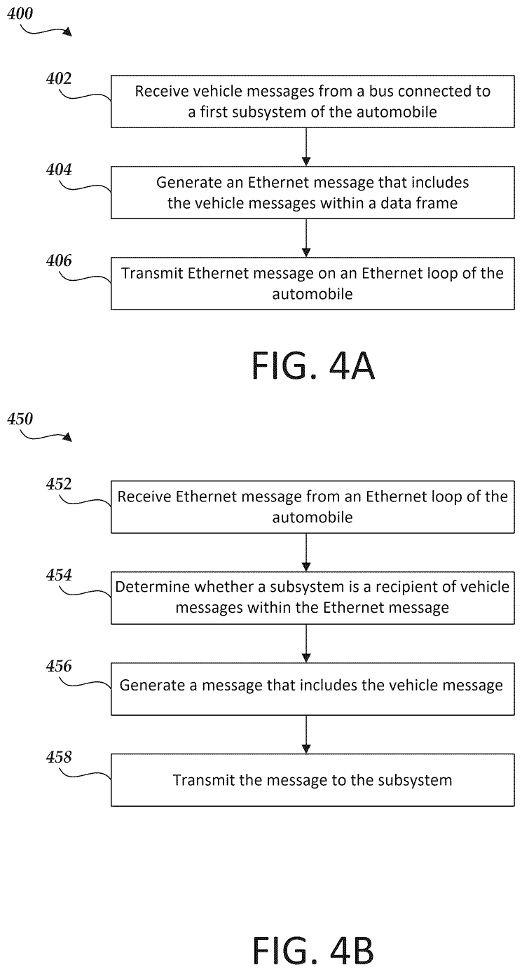

FIGS. 4A and 4B illustrate example processes that can be implemented by controllers of the vehicle to communicate vehicle messages on an Ethernet loop. While FIGS. 4A and 4B discuss the transmission of vehicle messages using an Ethernet loop, other data such as audio data (e.g. AAF data and CRF data) and synchronizing data (e.g. PTP data) may also be communicated on an Ethernet loop in the same, or similar, manner. According to some embodiments, the processes described in FIGS. 4A and 4B may omit steps, include different steps, or may be performed in a different order than illustrated in FIGS. 4A and 4B. FIGS. 4A and 4B can provide techniques for subsystems of a vehicle to communicate information as if connected directly by a bus (e.g., a CAN bus) even when connected to different controllers of the vehicle without direct bus communication.

FIG. 4A is an example process 400 for generating an Ethernet message at a controller, according to various implementations. At block 402, the controller receives one or more vehicle messages from a bus connect to a first subsystem of the automobile. The vehicle messages can include data from a CAN bus connected to the controller. The controller can also receive other data, such as AAF data, CRF data, PTP data, and/or TKM data. In some instances, a portion of the data may also be generated by the controller. For example, the controller may generate AAF data, CRF data, PTP data, and/or TKM data rather than receiving the data from a bus connected to the controller.

At block 404, the controller can generate an Ethernet message that includes the vehicle messages within a data frame of the Ethernet message. When generating the Ethernet message, the controller can reference a lookup table, such as lookup table 202 of FIG. 2, to encode additional information.

At block 406, the controller can transmit the Ethernet message on an Ethernet loop of the automobile (e.g., transmit the Ethernet message to other controllers networked in a loop topology in the automobile). In some instances, the Ethernet message can be transmitted bi-directionally on the Ethernet loop, such as is illustrated by ethernet message 152 and ethernet message 154 of FIG. 1B. In other instances, the Ethernet message may be transmitted in only one direction on the Ethernet loop. For example, Ethernet messages with audio data may be transmitted in a single direction on the Ethernet loop. According to some embodiments, the controller does not designate a destination controller for the Ethernet message. Rather, each subsequent controller on the Ethernet loop can use information within the data frame of the Ethernet message (e.g., information in the header of each the vehicle messages) to determine whether to the subsequent controller will use the vehicle messages (e.g., by routing the vehicle message to a connected subsystem).

FIG. 4B is an example process 450 for a controller generating a message with vehicle messages based on an Ethernet message, according to various implementations. At block 452 the controller receives an Ethernet message from an Ethernet loop of the automobile. As described above, the Ethernet message can include one or more vehicle messages (e.g., the vehicle payload data 304 of FIG. 3B). The Ethernet message can also include additional data, as shown in the Ethernet message 302 of FIG. 3A.

At block 454, the controller can determine whether a subsystem of the automobile (or the controller itself) is a recipient of vehicle messages within the Ethernet message. To do this, the controller can compare a portion of the data in the Ethernet message (e.g., headers of the vehicle messages within a data frame of the Ethernet message) to a lookup table to determine if a subsystems connected to the controller (or the controller itself) is a recipient of one or more the vehicle messages in the Ethernet message.

If the controller determines a subsystem of the automobile (or the controller itself) is a recipient of a vehicle message within the Ethernet message, at block 456, the controller can generate a message that includes the vehicle messages. For example, the controller can extract vehicle messages from the data frame of the Ethernet message and generate a message that includes the vehicle messages.

At block 458, the controller can transmit the message to the subsystem. For example, the controller can transmit the message with the vehicle messages generated at block 456 to a subsystem connected to the controller.

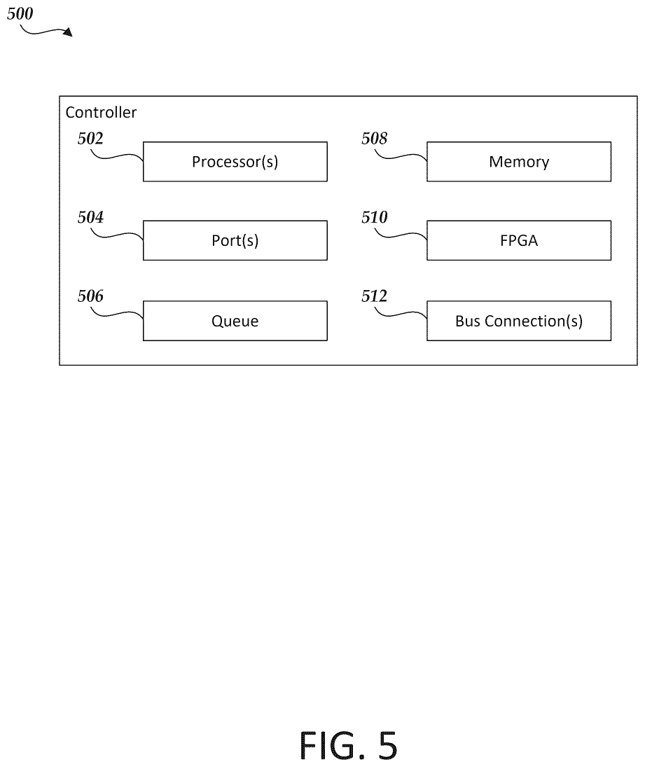

FIG. 5 is a block diagram illustrating an example controller 500 that can be used in a vehicle, according to an embodiment. The architecture of FIG. 5 is illustrative in nature and should not be construed as requiring any specific hardware or software configuration for the processing component. The general architecture of the controller 500 of a vehicle depicted in FIG. 5 includes an arrangement of computer hardware and software components that may be used to implement aspects of the present disclosure. As illustrated, the controller 500 includes one or more processors 502, one or more ports 504, one or more queues 506, memory 508, one or more field programable gate arrays (FPGA) 510, and one or more bus connections 512. The components of the controller 500 may be physical hardware components that can include one or more circuitries and software models.

The processors 502 can include any hardware or software computer processor, logic unit, a digital signal processor (DSP), an application specific integrated circuit (ASIC), discrete gate or transistor logic, discrete hardware components, or any combination thereof designed to perform the functions described herein. The processors 502 can be a microprocessors, but in the alternative, the processors 502 can be controllers, microcontrollers, or state machines, combinations of the same, or the like. The processors 502 can include electrical circuitry configured to process computer-executable instructions. In another embodiment, the processors 502 includes FPGAs or other programmable device that performs logic operations without processing computer-executable instructions. The processors 502 can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, the processors 502 may also include primarily analog components. For example, some or all of the processing described herein may be implemented in analog circuitry or mixed analog and digital circuitry.

The ports 504 can include any of the features described with respect to ports 162 of FIGS. 1B and 2. The ports 504 may be a physical port and may include various hardware components such as switches. The ports 504 may interact with the queues 506, memory 508, and the FPGA 510 to perform the ingress and egress operations described in FIG. 2. The queues 506 can include any of the features described with respect to the queues 164 of FIG. 1B.

The memory 508 may include computer program instructions that the processor 502 executes in order to implement one or more embodiments. The memory 508 generally includes RAM, ROM, or other persistent or non-transitory memory. The memory 508 may store an operating system that provides computer program instructions for use by the processors 502 in the general administration and operation of the controller 500. The memory 508 may further include computer program instructions and other information for implementing aspects of the present disclosure.

The FPGAs 510 may be used to perform some of the operations of the processors 502, the ports 504, the queues 506, the memory 508, and/or the bus connections 512. The bus connections 512 can include any of the features described with respect to buses 114 of FIG. 1B. The bus connections 512 can provide communication to subsystems connected to the controller 500. The bus connections 512 can include CAN buses.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A wiring system for an automobile comprising:
a plurality of controllers networked in a loop topology and configured to encode and decode packets bi-directionally on the loop using Ethernet messages, the plurality of controllers comprising:
a first controller comprising one or more processors and configured to:
receive one or more vehicle messages from a first Controller Area Network (“CAN”) bus connected to a first subsystem of the automobile,
generate an Ethernet message that includes the one or more vehicle messages within a data frame, and
transmit the Ethernet message on the loop in two directions; and
a second controller comprising one or more processors and, the second controller configured to:
receive the Ethernet message from the loop,
determine whether a second subsystem of the automobile is a recipient of the one or more vehicle messages,
generate a message that includes the one or more vehicle messages, and
transmit the message on a second CAN bus connected to the second subsystem of the automobile.

2. The wiring system of claim 1, wherein to determine that the second subsystem of the automobile is the recipient of the one or more vehicle messages, the second controller uses identification information in a header of the one or more vehicle messages.

3. The wiring system of claim 2, wherein the identification information reflects a type of the one or more vehicle messages.

4. The wiring system of claim 1, wherein the second controller is further configured to:
receive a second copy of the Ethernet message; and
discard the second copy of the Ethernet message.

5. The wiring system of claim 1, wherein the plurality of controllers further comprises a third controller comprising one or more processors, the third controller being an infotainment controller, and the third controller being configured to:
generate a second Ethernet message that includes audio data; and
transmit the second Ethernet message on the loop in a single direction.

6. The wiring system of claim 1, wherein to determine whether the second subsystem of the automobile is the recipient of the one or more vehicle messages, the second controller is configured to compare a portion of the one or more vehicle messages to a lookup table.

7. The wiring system of claim 1, wherein a size of the data frame of the Ethernet message is configured to be dynamically allocated based on an amount of the one or more vehicle messages.

8. The wiring system of claim 1, wherein the first controller is further configured to receive a second one or more vehicle messages, and wherein the Ethernet message generated by the first controller includes the second one or more vehicle messages.

9. The wiring system of claim 8, wherein the first controller receives the second one or more vehicle messages from a third CAN bus connected to a third subsystem of the automobile.

10. The wiring system of claim 8, wherein the plurality of controllers further comprises a third controller comprising one or more processors and configured to:
receive the Ethernet message from the loop;
determine whether a fourth subsystem of the automobile is a recipient of the second one or more vehicle messages;
generate a second message that includes the second one or more vehicle messages; and
transmit the second message on a fourth CAN bus connected to the fourth subsystem of the automobile.

11. A method comprising:
generating, by a first controller of a plurality of controllers, an Ethernet message that includes one or more vehicle messages within a data frame, the plurality of controllers networked in a loop topology and configured to encode and decode packets bi-directionally on the loop using Ethernet messages;
transmitting, by the first controller, the Ethernet message on the loop;
by each successive controller of the plurality of controllers along the loop:
receiving the Ethernet message;
determining whether at least one subsystem of an automobile connected to the successive controller is a recipient of the one or more vehicle messages;
based on the determination that the at least one subsystem is the recipient of the one or more vehicle messages, generating a message that includes the one or more vehicle messages; and
transmitting the message on a Controller Area Network (“CAN”) bus connected to the at least one subsystem.

12. The method of claim 11, further comprising:
receiving, by the first controller, the one or more vehicle messages from a subsystem of the automobile connected to the first controller.

13. The method of claim 11, wherein determining whether at least one subsystem of an automobile connected to the successive controller is a recipient of the one or more vehicle messages comprises using identification information in a header of the one or more vehicle messages.

14. The method of claim 13, wherein the identification information reflects a type of one or more vehicle messages.

15. The method of claim 11, further comprising, by each successive controller of the of successive controllers along the loop:
receiving a second copy of the Ethernet message; and
discarding the second copy of the Ethernet message.

16. The method of claim 11, wherein determining whether the subsystem of the automobile connected to the successive controller is the recipient of the one or more vehicle messages comprises comparing a portion of the one or more vehicle messages to a lookup table.

17. The method of claim 11, further comprising, by the first controller, dynamically allocating a size of the data frame of the Ethernet message based on an amount of the one or more vehicle messages.

18. The method of claim 11, further comprising:
generating, by the first controller, an additional Ethernet message that includes an additional one or more vehicle messages within the data frame;
by each successive controller of the plurality of controllers along the loop:
receiving the additional Ethernet message;
determining whether the subsystem of the automobile connected to the successive controller is a recipient of the additional one or more vehicle messages;
based on the determination that the at least one subsystem is a recipient of the additional one or more vehicle messages, generating an additional message that includes the additional one or more vehicle messages; and
transmitting the additional message on the CAN bus connected to the at least one subsystem.

19. The method of claim 11, further comprising, by each successive controller of the of successive controllers along the loop:
based on the determination that the at least one subsystem is the recipient of the one or more vehicle messages, storing the one or more vehicle messages in a queue, wherein the message includes all vehicle messages stored in the queue.

20. The method of claim 19, wherein generating the message comprises generating the message from all vehicle messages stored in the queue at set intervals.
